(19) United States
(12) Patent Application Publication
(10) Pub. No.: US 2020/0337117 A1
(43) Pub. Date: Oct. 22, 2020

(54) LOCATION ADJUSTABLE COUPLING

(71) Applicant: Wilson Electronics, LLC, St. George, UT (US)

(72) Inventors: Christopher Ken Ashworth, Toquerville, UT (US); Casey James Nordgran, Washington, UT (US); Samuel Vaughn Judd, St. George, UT (US)

(21) Appl. No.: 16/883,962

(22) Filed: May 26, 2020

Related U.S. Application Data
(60) Provisional application No. 62/852,882, filed on May 24, 2019.

(51) Int. Cl. H04W 88/08; H04W 72/08; H01Q 1/22

(52) U.S. Cl. CPC H04W 88/085; H01Q 1/2258; H04W 72/082

(57) ABSTRACT

A technology is described for a user equipment (UE) dock configured to retain a UE. The UE dock can comprise: a cradle; and a coupling antenna carried by the cradle. The coupling antenna can be movable to a plurality of physical locations relative to the cradle to minimize a coupling loss between the coupling antenna and a UE antenna.

### RELATED APPLICATIONS

The present application claims the benefit of U.S. Provisional Patent Application No. 62/852,882 filed May 24, 2019 with a docket number of 3969-123.PROV, the entire specification of which is hereby incorporated by reference in its entirety for all purposes.

### BACKGROUND

Repeaters can be used to increase the quality of wireless communication between a wireless device and a wireless communication access point, such as a cell tower. Repeaters can improve the quality of the wireless communication by amplifying, filtering, and/or applying other processing techniques to uplink and downlink signals communicated between the wireless device and the wireless communication access point.

As an example, the repeater can receive, via an antenna, downlink signals from the wireless communication access point. The repeater can amplify the downlink signal and then provide an amplified downlink signal to the wireless device. In other words, the repeater can act as a relay between the wireless device and the wireless communication access point. As a result, the wireless device can receive a stronger signal from the wireless communication access point. Similarly, uplink signals from the wireless device (e.g., telephone calls and other data) can be received at the repeater. The repeater can amplify the uplink signals before communicating, via an antenna, the uplink signals to the wireless communication access point.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure;

and, wherein:

FIG. 1 illustrates a user equipment (UE) dock in accordance with an example;

FIG. 2 illustrates a repeater in accordance with an example;

FIG. 3 illustrates a repeater in communication with a user equipment (UE) and a base station (BS) in accordance with an example;

FIG. 4 illustrates a user equipment (UE) dock in accordance with an example;

FIG. 5 illustrates a user equipment (UE) dock in accordance with an example;

FIG. 6 illustrates a user equipment (UE) dock with one or more coupling antennas in accordance with an example;

FIG. 7 illustrates a rear section of a user equipment (UE) dock in accordance with an example;

FIG. 8 illustrates components of a user equipment (UE) dock in accordance with an example;

FIG. 9 illustrates a side view of components of a user equipment (UE) dock in accordance with an example;

FIG. 10 illustrates a mechanical means to hold a user equipment (UE) within a UE dock in accordance with an example;

FIG. 11 illustrates a user equipment (UE) in accordance with an example;

FIG. 12 depicts a user equipment (UE) dock in accordance with an example;

FIG. 13 depicts a user equipment (UE) dock in accordance with an example;

FIG. 14 depicts a user equipment (UE) dock in accordance with an example; and

FIG. 15 depicts a repeater system in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Contemporary technology can include a wide range of mobile telephones that have increased in popularity in recent years. An expanding number of people and enterprises rely on mobile phone usage, cellular network strength, and obtaining the best possible connection in heavily trafficked, populated, and barren areas. This expansion in mobile phone use has resulted in a demand for reliable cellular signal coverage over a wider area.

Mobile phone use in heavily populated areas often results in bandwidth allocation issues with local cell towers. Using mobile phones in areas with a weak signal often results in dropped calls which can be both annoying for the mobile phone user and expensive for the wireless service provider. This often occurs in locations with a loss of signal, most notably in barren areas, or areas with limited cell coverage or towers to provide a strong signal. This loss of signal can occur for a number of reasons, including interference due to buildings or mountains and/or an increase in distance between the mobile phone and the base station. In one situation, dropped calls can be prevalent when the mobile phone user is driving long distances in remote areas with few base stations capable of reliably receiving a signal from a mobile phone.

Mobile devices can often have internal phone antennas located in various locations. As such, various interferences caused by the user and surrounding circumstances as described above, can cause a loss of signal. In some cases, a large antenna can be attached to the mobile device. However, large antennas can be costly and unsightly. Large antennas can also limit connection and identification options.

These limitations can be overcome by using a device cradle configured to removably receive handsets and other mobile devices. The device cradle can be coupled with antennas and/or amplifiers to improve the cellular network signal between the mobile device and the cellular network.

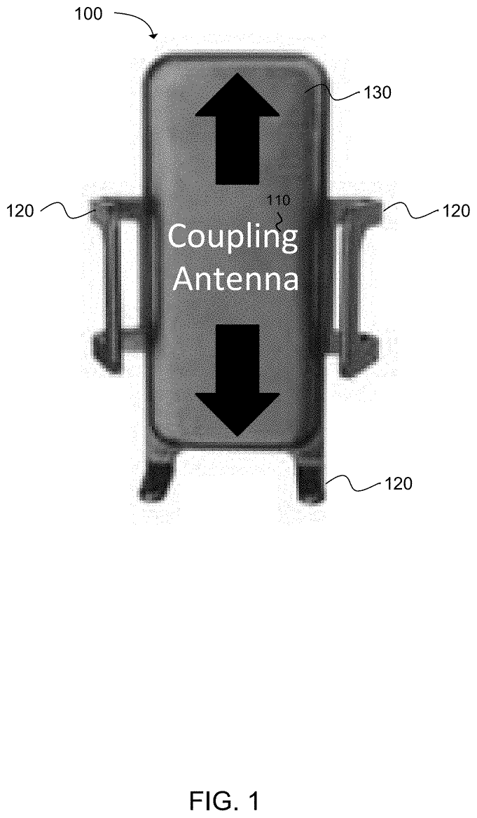

In another example, as illustrated in FIG. 1, a user equipment (UE) dock 100 can comprise a cradle 130 and a coupling antenna 110 carried by the cradle 130. The coupling antenna 110 can be configured to be movable to plurality of physical locations relative to a location on the cradle 130 to minimize a coupling loss between the coupling antenna 110 and one or more UE antennas. The UE can be configured to communicate using the one or more UE antennas. The UE dock 100 can comprise one or more attaching members 120 extending from the cradle 130.

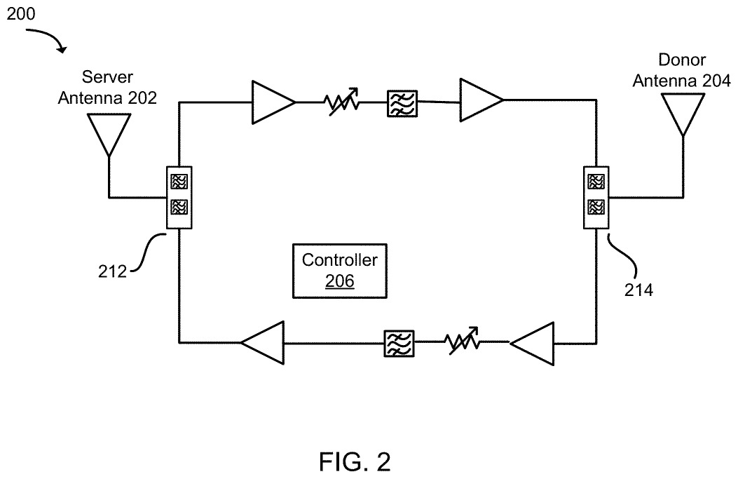

In an example, as illustrated in FIG. 2, a bi-directional repeater system can comprise a repeater 200 connected to an outside antenna 204 or donor antenna 204 and an inside antenna 202 or server antenna 202. The repeater 200 can include a donor antenna port that can be internally coupled to a second duplexer (or diplexer or multiplexer or circulator or splitter) 214. The repeater 200 can include a server antenna port that can also be coupled to a first duplexer (or diplexer or multiplexer or circulator or splitter) 212. Between the two duplexers, 214 and 212, can be two paths: a first path and a second path. The first path can comprise a low noise amplifier (LNA) with an input coupled to the first duplexer 212, a variable attenuator coupled to an output of the LNA, a filter coupled to the variable attenuator, and a power amplifier (PA) coupled between the filter and the second duplexer 214. The LNA can amplify a lower power signal without degrading the signal to noise ratio. The PA can adjust and amplify the power level by a desired amount. A second path can comprise an LNA with an input coupled to the second duplexer 214, a variable attenuator coupled to an output of the LNA, a filter coupled to the variable attenuator, and a PA coupled between the filter and the first duplexer 212. The first path can be a downlink amplification path or an uplink amplification path. The second path can be a downlink amplification path or an uplink amplification path. The repeater 200 can also comprise a controller 206. In one example, the controller 206 can include one or more processors and memory.

In some embodiments the controller 206 can adjust the gain of the first path and/or the second path based on wireless communication conditions. If included in the repeater 200, the controller 206 can be implemented by any suitable mechanism, such as a program, software, function, library, software as a service, analog or digital circuitry, or any combination thereof. The controller 206 can also include a processor coupled to memory. The processor can include, for example, a microprocessor, microcontroller, digital signal processor (DSP), application specific integrated circuit (ASIC), a Field Programmable Gate Array (FPGA), or any other digital or analog circuitry configured to interpret and/or to execute program instructions and/or to process data. In some embodiments, the processor can interpret and/or execute program instructions and/or process data stored in the memory. The instructions can include instructions for adjusting the gain of the first path and/or the second path. For example, the adjustments can be based on radio frequency (RF) signal inputs.

The memory can include any suitable computer readable media configured to retain program instructions and/or data for a period of time. By way of example, and not limitation, such computer readable media can include tangible computer readable storage media including random access memory (RAM), read only memory (ROM), electrically erasable programmable read only memory (EEPROM), a compact disk (CD) ROM or other optical disk storage, magnetic disk storage or other magnetic storage devices, flash memory devices (e.g., solid state memory devices) or any other storage medium which can be used to carry or store desired program code in the form of computer executable instructions or data structures and which can be accessed by a general purpose or special purpose computer. Combinations of the above can also be included within the scope of computer readable media. Computer executable instructions can include, for example, instructions and data that cause a general purpose computer, special purpose computer, or special purpose processing device to perform a certain function or group of functions.

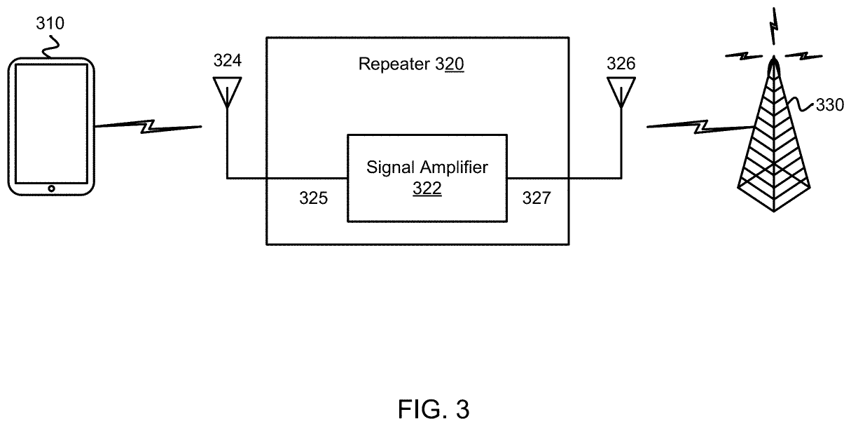

FIG. 3 illustrates an exemplary repeater 320 in communication with a wireless device 310 and a base station 330. The repeater 320 (also referred to as a cellular signal amplifier) can improve the quality of wireless communication by amplifying, filtering, and/or applying other processing techniques via a signal amplifier 322 to uplink signals communicated from the wireless device 310 to the base station 330 and/or downlink signals communicated from the base station 330 to the wireless device 310. In other words, the repeater 320 can amplify or boost uplink signals and/or downlink signals bi-directionally. In one example, the repeater 320 can be at a fixed location, such as in a home or office. Alternatively, the repeater 320 can be attached to a mobile object, such as a vehicle or a wireless device 310. The repeater can be a signal booster, such as a cellular signal booster.

In one configuration, the repeater 320 can be configured to be connected to a device antenna 324 (e.g., an inside antenna, server antenna, or a coupling antenna) and a node antenna 326 (e.g., an outside antenna or donor antenna). The node antenna 326 can receive the downlink signal from the base station 330. The downlink signal can be provided to the signal amplifier 322 via a second coaxial cable 327 or other type of wired, wireless, optical, or radio frequency connection operable to communicate radio frequency signals. The signal amplifier 322 can include one or more radio signal amplifiers for amplification and filtering of cellular signals. The downlink signal that has been amplified and filtered can be provided to the device antenna 324 via a first coaxial cable 325 or other type of radio frequency connection operable to communicate radio frequency signals. The device antenna 324 can communicate the downlink signal that has been amplified and filtered to the wireless device 310.

Similarly, the device antenna 324 can receive an uplink signal from the wireless device 310. The uplink signal can be provided to the signal amplifier 322 via the first coaxial cable 325 or other type of wired, wireless, optical, or radio frequency connection operable to communicate radio frequency signals. The signal amplifier 322 can include one or more radio signal amplifiers for amplification and filtering of cellular signals. The uplink signal that has been amplified and filtered can be provided to the node antenna 326 via the second coaxial cable 327 or other type of wired, wireless, optical, or radio frequency connection operable to communicate radio frequency signals. The node antenna 326 can communicate the uplink signal that has been amplified and filtered to a node, such as a base station 330.

In one embodiment, the device antenna 324 and the node antenna 326 can be integrated as part of the repeater 320. Alternatively, the repeater 320 can be configured to be connected to a separate device antenna 324 or node antenna 326. The device antenna and the node antenna may be provided by a different provider than the repeater 320.

In one example, the repeater 320 can send uplink signals to a node and/or receive downlink signals from the node. While FIG. 3 shows the node as a base station 330, this is not intended to be limiting. The node can comprise a wireless wide area network (WWAN) access point (AP), a base station (BS), an evolved Node B (eNB), a next generation Node B (gNB), a new radio base station (NR BS), a baseband unit (BBU), a remote radio head (RRH), a remote radio equipment (RRE), a relay station (RS), a radio equipment (RE), a remote radio unit (RRU), a central processing module (CPM), or another type of WWAN access point.

In one configuration, the repeater 320 used to amplify the uplink and/or a downlink signal can be a handheld booster. The handheld booster can be implemented in a sleeve of the wireless device 310. The wireless device sleeve may be attached to the wireless device 310, but may be removed as needed. In this configuration, the repeater 320 can automatically power down or cease amplification when the wireless device 310 approaches a particular base station.

In other words, the repeater 320 may determine to stop performing signal amplification when the quality of uplink and/or downlink signals is above a defined threshold based on a location of the wireless device 310 in relation to the base station 330.

In one example, the repeater 320 can include a battery to provide power to various components, such as the signal amplifier 322, the device antenna 324, and the node antenna 326. The battery can also power the wireless device 310 (e.g., phone or tablet). Alternatively, the repeater 320 can receive power from the wireless device 310.

In one configuration, the repeater 320 can be a Federal Communications Commission (FCC)-compatible consumer repeater. As a non-limiting example, the repeater 320 can be compatible with FCC Part 20 or 47 Code of Federal Regulations (C.F.R.) Part 20.21 (Mar. 21, 2013). In addition, the handheld booster can operate on the frequencies used for the provision of subscriber-based services under parts 22 (Cellular), 24 (Broadband PCS), 27 (AWS-1, 700 megahertz (MHz) Lower A-E Blocks, and 700 MHz Upper C Block), and 90 (Specialized Mobile Radio) of 47 C.F.R. The repeater 320 can be configured to automatically self-monitor its operation to ensure compliance with applicable noise and gain limits. The repeater 320 can either self-correct or shut down automatically if the repeater's operations violate the regulations defined in 47 CFR Part 20.21. While a repeater that is compatible with FCC regulations is provided as an example, it is not intended to be limiting. The repeater can be configured to be compatible with other governmental regulations based on the location where the repeater is configured to operate.

In one configuration, the repeater 320 can improve the wireless connection between the wireless device 310 and the base station 330 (e.g., cell tower) or another type of wireless wide area network (WWAN) access point (AP) by amplifying desired signals relative to a noise floor. The repeater 320 can boost signals for cellular standards, such as the Third Generation Partnership Project (3GPP) Long Term Evolution (LTE) Release 8, 9, 10, 11, 12, 13, 14, 15, or 16 standards or Institute of Electronics and Electrical Engineers (IEEE) 802.16. In one configuration, the repeater 320 can boost signals for 3GPP LTE Release 16.1.0 (March 2019) or other desired releases.

The repeater 320 can boost signals from the 3GPP Technical Specification (TS) 36.101 (Release 16 Jan. 2019) bands or LTE frequency bands. For example, the repeater 320 can boost signals from the LTE frequency bands: 2, 4, 5, 12, 13, 17, 25, and 26. In addition, the repeater 320 can boost selected frequency bands based on the country or region in which the repeater is used, including any of bands 1-85 or other bands, as disclosed in 3GPP TS 36.104 V16.1.0 (March 2019), and depicted in Table 1:

TABLE 1

| LTE | Uplink (UL) operating band | Downlink (DL) operating band | |
|---|---|---|---|
| Operating | BS receive UE transmit | BS transmit UE receive | Duplex |
| Band | F_{UL}_low-F_{UL}_high | F_{DL}_low-F_{DL}_high | Mode |
| 1 | 1920 MHz-1980 MHz | 2110 MHz-2170 MHz | FDD |
| 2 | 1850 MHz-1910 MHz | 1930 MHz-1990 MHz | FDD |
| 3 | 1710 MHz-1785 MHz | 1805 MHz-1880 MHz | FDD |
| 4 | 1710 MHz-1755 MHz | 2110 MHz-2155 MHz | FDD |
| 5 | 824 MHz-849 MHz | 869 MHz-894 MHz | FDD |
| 6 | 830 MHz-840 MHz | 875 MHz-885 MHz | FDD |
| (NOTE 1) | | | |
| 7 | 2500 MHz-2570 MHz | 2620 MHz-2690 MHz | FDD |
| 8 | 880 MHz-915 MHz | 925 MHz-960 MHz | FDD |
| 9 | 1749.9 MHz-1784.9 MHz | 1844.9 MHz-1879.9 MHz | FDD |
| 10 | 1710 MHz-1770 MHz | 2110 MHz-2170 MHz | FDD |
| 11 | 1427.9 MHz-1447.9 MHz | 1475.9 MHz-1495.9 MHz | FDD |
| 12 | 699 MHz-716 MHz | 729 MHz-746 MHz | FDD |
| 13 | 777 MHz-787 MHz | 746 MHz-756 MHz | FDD |
| 14 | 788 MHz-798 MHz | 758 MHz-768 MHz | FDD |
| 15 | Reserved | Reserved | FDD |
| 16 | Reserved | Reserved | FDD |
| 17 | 704 MHz-716 MHz | 734 MHz-746 MHz | FDD |
| 18 | 815 MHz-830 MHz | 860 MHz-875 MHz | FDD |
| 19 | 830 MHz-845 MHz | 875 MHz-890 MHz | FDD |
| 20 | 832 MHz-862 MHz | 791 MHz-821 MHz | FDD |
| 21 | 1447.9 MHz-1462.9 MHz | 1495.9 MHz-1510.9 MHz | FDD |
| 22 | 3410 MHz-3490 MHz | 3510 MHz-3590 MHz | FDD |
| 23¹ | 2000 MHz-2020 MHz | 2180 MHz-2200 MHz | FDD |
| 24 | 1626.5 MHz-1660.5 MHz | 1525 MHz-1559 MHz | FDD |
| 25 | 1850 MHz-1915 MHz | 1930 MHz-1995 MHz | FDD |
| 26 | 814 MHz-849 MHz | 859 MHz-894 MHz | FDD |
| 27 | 807 MHz-824 MHz | 852 MHz-869 MHz | FDD |
| 28 | 703 MHz-748 MHz | 758 MHz-803 MHz | FDD |
| 29 | N/A | 717 MHz-728 MHz | FDD |
| | | | (NOTE 2) |
| 30 | 2305 MHz-2315 MHz | 2350 MHz-2360 MHz | FDD |
| 31 | 452.5 MHz-457.5 MHz | 462.5 MHz-467.5 MHz | FDD |
| 32 | N/A | 1452 MHz-1496 MHz | FDD |
| | | | (NOTE 2) |
| 33 | 1900 MHz-1920 MHz | 1900 MHz-1920 MHz | TDD |
| 34 | 2010 MHz-2025 MHz | 2010 MHz-2025 MHz | TDD |
| 35 | 1850 MHz-1910 MHz | 1850 MHz-1910 MHz | TDD |
| 36 | 1930 MHz-1990 MHz | 1930 MHz-1990 MHz | TDD |
| 37 | 1910 MHz-1930 MHz | 1910 MHz-1930 MHz | TDD |
| 38 | 2570 MHz-2620 MHz | 2570 MHz-2620 MHz | TDD |
| 39 | 1880 MHz-1920 MHz | 1880 MHz-1920 MHz | TDD |
| 40 | 2300 MHz-2400 MHz | 2300 MHz-2400 MHz | TDD |
| 41 | 2496 MHz-2690 MHz | 2496 MHz-2690 MHz | TDD |
| 42 | 3400 MHz-3600 MHz | 3400 MHz-3600 MHz | TDD |
| 43 | 3600 MHz-3800 MHz | 3600 MHz-3800 MHz | TDD |
| 44 | 703 MHz-803 MHz | 703 MHz-803 MHz | TDD |
| 45 | 1447 MHz-1467 MHz | 1447 MHz-1467 MHz | TDD |
| 46 | 5150 MHz-5925 MHz | 5150 MHz-5925 MHz | TDD |
| | | | (NOTE 3, |
| | | | NOTE 4) |
| 47 | 5855 MHz-5925 MHz | 5855 MHz-5925 MHz | TDD |
| 48 | 3550 MHz-3700 MHz | 3550 MHz-3700 MHz | TDD |
| 49 | 3550 MHz-3700 MHz | 3550 MHz-3700 MHz | TDD |
| | | | (NOTE 8) |
| 50 | 1432 MHz-1517 MHz | 1432 MHz-1517 MHz | TDD |
| 51 | 1427 MHz-1432 MHz | 1427 MHz-1432 MHz | TDD |
| 52 | 3300 MHz-3400 MHz | 3300 MHz-3400 MHz | TDD |
| 53 | 2483.5 MHz-2495 MHz | 2483.5 MHz-2495 MHz | TDD |
| 65 | 1920 MHz-2010 MHz | 2110 MHz-2200 MHz | FDD |
| 66 | 1710 MHz-1780 MHz | 2110 MHz-2200 MHz | FDD |
| | | | (NOTE 5) |
| 67 | N/A | 738 MHz-758 MHz | FDD |
| | | | (NOTE 2) |
| 68 | 698 MHz-728 MHz | 753 MHz-783 MHz | FDD |
| 69 | N/A | 2570 MHz-2620 MHz | FDD |
| | | | (NOTE 2) |
| 70 | 1695 MHz-1710 MHz | 1995 MHz-2020 MHz | FDD⁶ |
| 71 | 663 MHz-698 MHz | 617 MHz-652 MHz | FDD |
| 72 | 451 MHz-456 MHz | 461 MHz-466 MHz | FDD |
| 73 | 450 MHz-455 MHz | 460 MHz-465 MHz | FDD |
| 74 | 1427 MHz-1470 MHz | 1475 MHz-1518 MHz | FDD |
| 75 | N/A | 1432 MHz-1517 MHz | FDD |
| | | | (NOTE 2) |
| 76 | N/A | 1427 MHz-1432 MHz | FDD |
| | | | (NOTE 2) |
| 85 | 698 MHz-716 MHz | 728 MHz-746 MHz | FDD |

(NOTE 1):
Band 6, 23 are not applicable.
(NOTE 2):
Restricted to E-UTRA operation when carrier aggregation is configured. The downlink operating band is paired with the uplink operating band (external) of the carrier aggregation configuration that is supporting the configured Pcell.
(NOTE 3):
This band is an unlicensed band restricted to licensed-assisted operation using Frame Structure Type 3.
(NOTE 4):
Band 46 is divided into four sub-bands as in Table 5.5-1A.
(NOTE 5):
The range 2180-2200 MHz of the DL operating band is restricted to E-UTRA operation when carrier aggregation is configured.
(NOTE 6):
The range 2010-2020 MHz of the DL operating band is restricted to E-UTRA operation when carrier aggregation is configured and TX-RX separation is 300 MHz. The range 2005-2020 MHz of the DL operating band is restricted to E-UTRA operation when carrier aggregation is configured and TX-RX separation is 295 MHz.
(NOTE 7):
Void
(NOTE 8):
This band is restricted to licensed-assisted operation using Frame Structure Type 3.

In another configuration, the repeater 320 can boost signals from the 3GPP Technical Specification (TS) 38.104 (Release 15 Jan. 2019) bands or 5G frequency bands. In addition, the repeater 320 can boost selected frequency bands based on the country or region in which the repeater is used, including any of bands n1-n86 in frequency range 1 (FR1), n257-n261 in frequency range 2 (FR2), or other bands, as disclosed in 3GPP TS 38.104 V15.5.0 (March 2019), and depicted in Table 2 and Table 3:

TABLE 2

| NR | Uplink (UL) operating band | Downlink (DL) operating band | |
|---|---|---|---|
| operating | BS receive/UE transmit | BS transmit/UE receive | Duplex |
| band | F_{UL, low}-F_{UL, high} | F_{DL, low}-F_{DL, high} | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n12 | 699 MHz-716 MHz | 729 MHz-746 MHz | FDD |
| n20 | 832 MHz-862 MHz | 791 MHz-821 MHz | FDD |
| n25 | 1850 MHz-1915 MHz | 1930 MHz-1995 MHz | FDD |
| n28 | 703 MHz-748 MHz | 758 MHz-803 MHz | FDD |
| n34 | 2010 MHz-2025 MHz | 2010 MHz-2025 MHz | TDD |
| n38 | 2570 MHz-2620 MHz | 2570 MHz-2620 MHz | TDD |
| n39 | 1880 MHz-1920 MHz | 1880 MHz-1920 MHz | TDD |
| n40 | 2300 MHz-2400 MHz | 2300 MHz-2400 MHz | TDD |
| n41 | 2496 MHz-2690 MHz | 2496 MHz-2690 MHz | TDD |
| n50 | 1432 MHz-1517 MHz | 1432 MHz-1517 MHz | TDD |
| n51 | 1427 MHz-1432 MHz | 1427 MHz-1432 MHz | TDD |
| n65 | 1920 MHz-2010 MHz | 2110 MHz-2200 MHz | FDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |
| n86 | 1710 MHz-1780 MHz | N/A | SUL |

TABLE 3

| | Uplink (UL) and Downlink | |
|---|---|---|
| | (DL)operating band | |
| | BS transmit/receive | |
| NR | UE transmit/receive | |
| operating | F_{UL, low}-F_{UL, high} | Duplex |
| band | F_{DL, low}-F_{DL, high} | Mode |
| n257 | 26500 MHz-29500 MHz | TDD |
| n258 | 24250 MHz-27500 MHz | TDD |
| n260 | 37000 MHz-40000 MHz | TDD |
| n261 | 27500 MHz-28350 MHz | TDD |

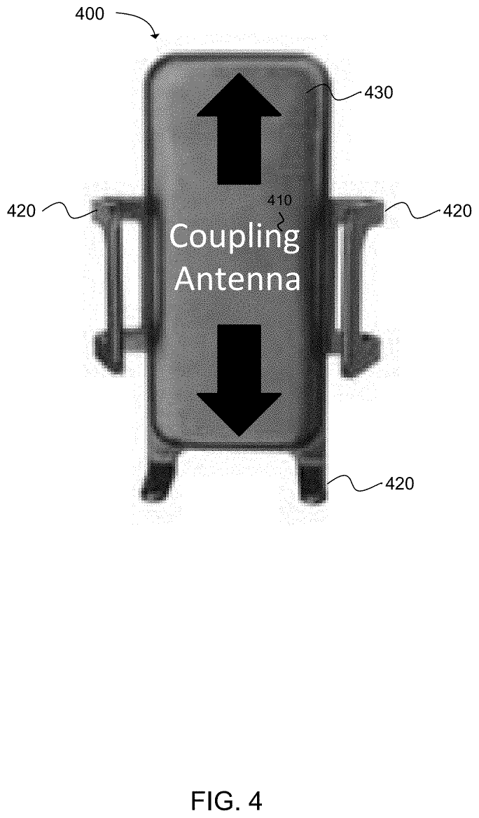

In another example, as illustrated in FIG. 4, a user equipment (UE) dock 400 can comprise a cradle 430 and a coupling antenna 410 carried by the cradle 430. The coupling antenna 410 can be configured to be movable to plurality of physical locations relative to a location on the cradle 430 to minimize a coupling loss between the coupling antenna 410 and one or more UE antennas. The UE can be configured to communicate using the one or more UE antennas.

In another example, a cradle-type repeater can be permitted to have a 23 decibel (dB) maximum gain between an output of a server antenna at the cradle 430 coupled to the repeater relative to an input of a donor antenna of the repeater. A fixed coupling antenna can have a substantial coupling loss between the fixed coupling antenna and a UE antenna in a range of 6 dB of loss to 30 dB of loss.

In another example, a movable coupling antenna 410 can be configured to minimize the coupling loss between the coupling antenna 410 and the one or more UE antennas by reducing the proximity between the coupling antenna 410 and the one or more UE antennas.

In another example, the coupling antenna 410 can be manually movable (e.g., by a user) relative to a reference location on the cradle 430. For example, the coupling antenna 410 can be configured to be coupled to a UE using magnets or other detachable means.

In another example, the coupling antenna 410 can be automatically movable (e.g., using a motor) relative to a reference location on the cradle 430. A motor can be configured to be attached to one or more of the UE dock 400 and the coupling antenna 410. The motor can be configured to automatically move the coupling antenna 410 relative to a reference location on the cradle 430.

In another example, the UE dock can further comprise a controller configured to determine an optimal coupling location based on feedback received from one or more of a UE or a repeater in communication with the UE dock. The feedback can comprise a received signal strength indicator (RSSI) that can be communicated from an application on a UE or from a repeater configured to communicate with the UE dock. The coupling antenna 410 can be movable from a first location on the cradle 430 to a second location on the cradle 430 based on the feedback.

In another example, the UE dock can comprise one or more attaching members 420 extending from the cradle 430. The one or more attaching members 420 can be configured to receive a UE into the cradle and retain a UE that has been received into the cradle to secure the UE to the cradle. The cradle 430 or UE dock 400 can also comprise a back portion of the cradle 430.

In another example, the coupling antenna 410 can be configured to be movable vertically relative to a reference location on the cradle in an upward direction or a downward direction. The coupling antenna 410 can be configured to be movable horizontally relative to a reference location on the cradle in a left-ward direction or a right-ward direction.

In another example, the coupling antenna 410 can have a width that is substantially similar to a width of the cradle 430. The coupling antenna 410 can have a width that is less than a width of the cradle 430.

In another example, the coupling antenna 410 can be coiled within an expandable cradle 430 to allow the coupling antenna 410 to expand relative to an expanding of the cradle 430. In another example, the coupling antenna 410 can be movable to a plurality of physical locations relative to a reference location on the expandable cradle 430 to minimize a coupling loss between the coupling antenna 410 and the UE antenna. In another example, the coupling antenna 410 can be movable to a plurality of physical locations relative to an absolute reference location but fixed relative to a reference location on the expandable cradle 430 to minimize a coupling loss between the coupling antenna 410 and the UE antenna. In another example, the expandable cradle 430 can be configured to extend one or more of a length or a width of the expandable cradle 430 to a length or a width of a UE.

In another example, a repeater system can comprise a repeater. The repeater can comprise: a first port (e.g., a server port), a second port (e.g., a donor port), a first amplification and filtering path coupled between the first port and the second port, a second amplification and filtering path coupled between the first port and the second port. The first amplification and filtering path can be configured to amplify or filter a first-direction signal (e.g., an uplink (UL) signal) of a first frequency range (e.g., a 3GPP LTE or 5G channel, band, combined bands, or any subset or superset thereof). The second amplification and filtering path can be configured to amplify or filter a second-direction signal (e.g., a downlink (DL) signal) of a first frequency range (e.g., a 3GPP LTE or 5G channel, band, combined bands, or any subset or superset thereof).

In another example, the coupling antenna 410 can be configured to be coupled to one or more of the cradle 430 or a first port of the repeater. The coupling antenna 410 can be movable to minimize a coupling loss between the coupling antenna and a UE antenna.

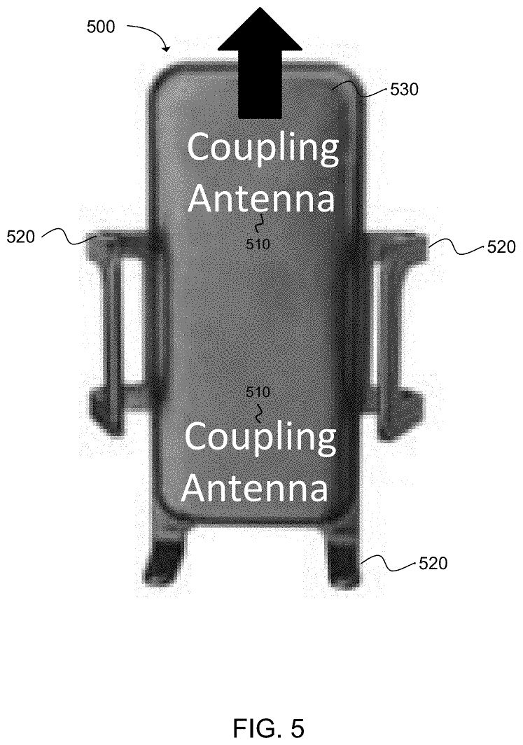

In another example, as illustrated in FIG. 5, a UE dock 500 can comprise an additional coupling antenna 510 or second coupling antenna 510. The second coupling antenna can be movable to a plurality of physical locations relative to a reference location on the cradle 530. The second coupling antenna 510 can be positioned in a lower or upper portion of the cradle, and the coupling antenna 510 can be positioned in a lower or upper portion of the cradle. The coupling antenna can be located in a lower portion or upper portion of the cradle 530 that is different from the lower portion or upper portion of the cradle 530 that the second coupling antenna is located in. In another example, the second coupling antenna can be configured to be coupled to a second UE antenna. The coupling antenna and the second coupling antenna can be configured to be connected or coupled using one or more of a splitter or a diplexer.

In another example, the UE dock can further comprise a controller configured to determine an optimal coupling location for the second coupling antenna based on feedback received from one or more of a UE or a repeater in communication with the UE dock. The feedback can comprise a received signal strength indicator (RSSI) that can be communicated from an application on a UE or from a repeater configured to communicate with the UE dock. The second coupling antenna 510 can be movable from a first location on the cradle 530 to a second location on the cradle 530 based on the feedback.

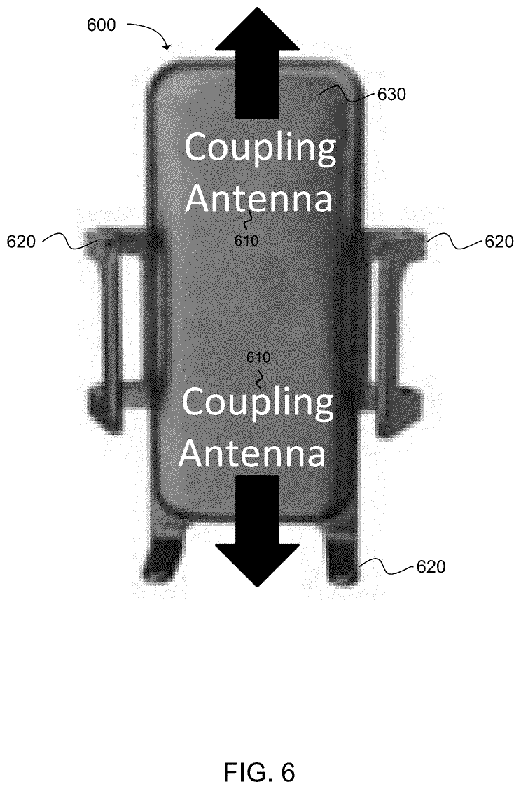

In another example, as illustrated in FIG. 6, a first coupling antenna 610 and a second coupling antenna 610 can be movable from a first location on the cradle 630 to a second location on the cradle 630 independently of the other coupling antenna. In another example, the first or second coupling antennas 610 can be movable to a plurality of physical locations relative to an absolute reference location but fixed relative to a reference location on an expandable cradle 630 to minimize a coupling loss between the first and second coupling antennas 610 and the UE antenna. In another example, the expandable cradle 630 can be configured to extend one or more of a length or a width of the expandable cradle 630 to a length or a width of a UE.

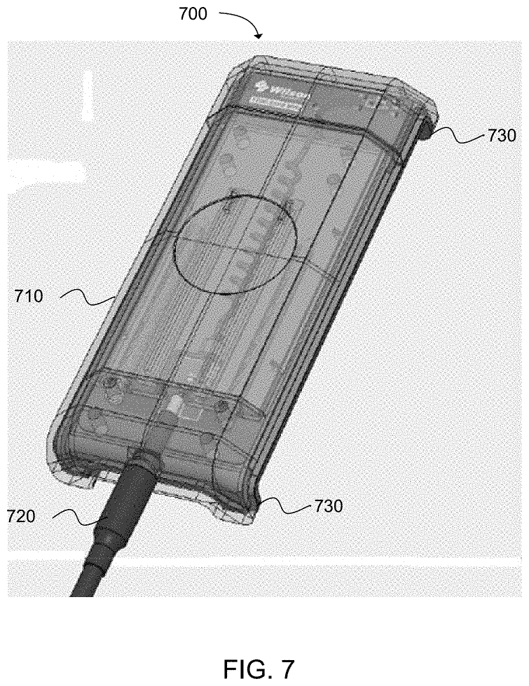

In another example, FIG. 7 illustrates a rear section of a UE dock 700. The UE dock 700 or cradle 730 can have an enclosure 710 that retains and protects the inner components of the UE dock 700. The UE dock 700 can comprise retaining portions or attaching members 730 that are operable to retain a device or user equipment. The UE dock 700 can also comprise a strain relief boot 720 operable to protect coupling antennas or other cable components from extreme bending, fatigue, and weather.

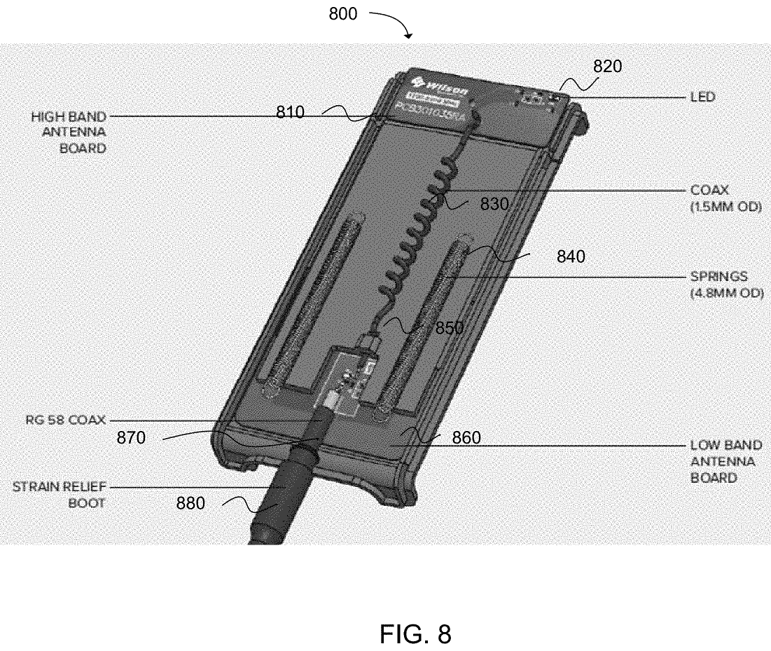

In another example, FIG. 8 illustrates components that can be used for operation of a UE dock 800, and also retained by the rear section as disclosed in FIG. 7. The UE dock 800 can comprise a high band antenna board 810 operable to support a high band antenna in the upper portion of the cradle and a low band antenna board 860 operable to support a low band antenna in the lower portion of the cradle.

The UE dock 800 can also comprise an LED 820 that can be located on the cradle, where it can be easily visible by a user, for indication or notification of the operability of the cradle and connectivity. The UE dock can also comprise a strain relief boot 880 that can be further coupled to RG 58 Coax cable 870, wherein the strain relief boot can be operable to protect coupling antennas and other cable components from extreme bending, fatigue, and weather. In addition, the RG 58 Coax cable 870 can be removably coupled, via a connector 850, to the low band antenna board 860 that can be coupled to an expandable coaxial cable 830. The coaxial cable 830 is expandable, upon the expansion of the cradle or UE dock 800 manually or automatically via a motor. The cradle or UE dock 800 can be expanded by the use of springs 840, that can be expandable relative to the expansion of the coaxial cable 830, upon the expansion of the cradle or UE dock 800.

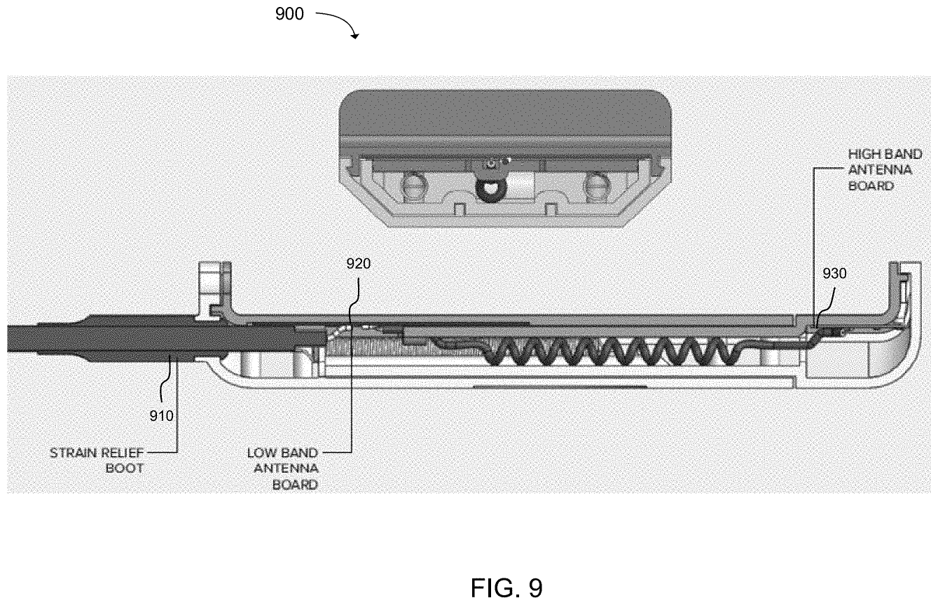

In another example, FIG. 9 illustrates a side-view of components that can be used for operation of a UE dock 900. The strain relief boot 910 can be coupled with the low band antenna board 920. The low band antenna board 920 can be coupled to an expandable coaxial cable 930. The coaxial cable 930 can be expandable, upon the expansion of the cradle or UE dock 900, manually or automatically via a motor. The cradle or UE dock 900 can be expanded by the use of springs that can be expanded relative to the expansion of the coaxial cable 930, upon the expansion of the cradle or UE dock 900.

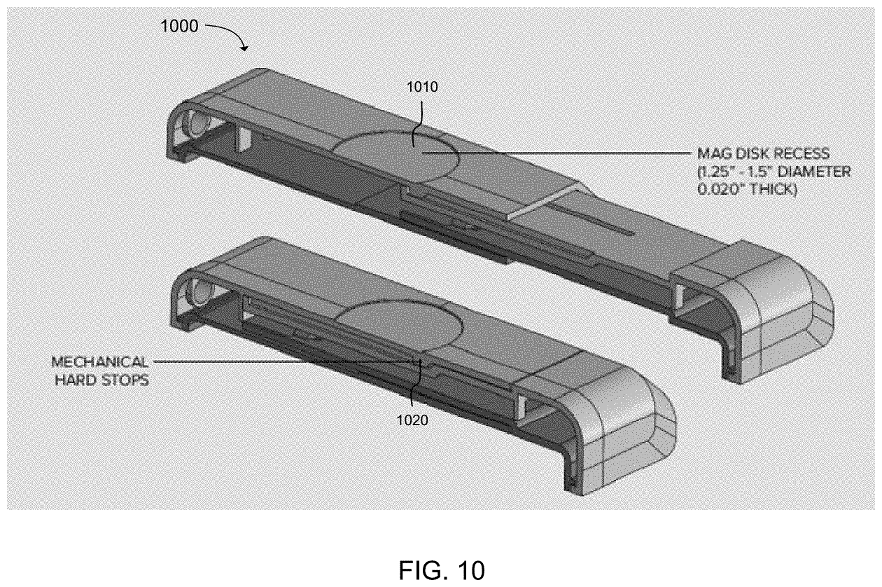

In another example, FIG. 10 illustrates a mechanical means 1000 used to retain a UE within the UE dock. The mechanical means 1000 can comprise a MAG Disk Recess 1010. The MAG Disk Recess 1010 can be between 1.25 inches to 1.5 inches in diameter and 0.020 inches thick. The mechanical means 1000 can also comprise mechanical hard stops 1020 operable to retain a device or user equipment. The mechanical hard stops 1020 can provide means to prevent slippage of the UE or device.

Although the preceding example have been described with reference to a device cradle that may only receive a single UE, the disclosure can be extended to include a plurality of UEs. Even with only a single UE in the cradle, other UEs within the vicinity of the cradle can use the amplifier or antenna associated with the cradle to amplify, filter, and process an uplink signal transmitted from the UEs to the cradle via a wireless connection. Thus, a single cradle can be used to amplify, filter, and process signals for a plurality of devices.

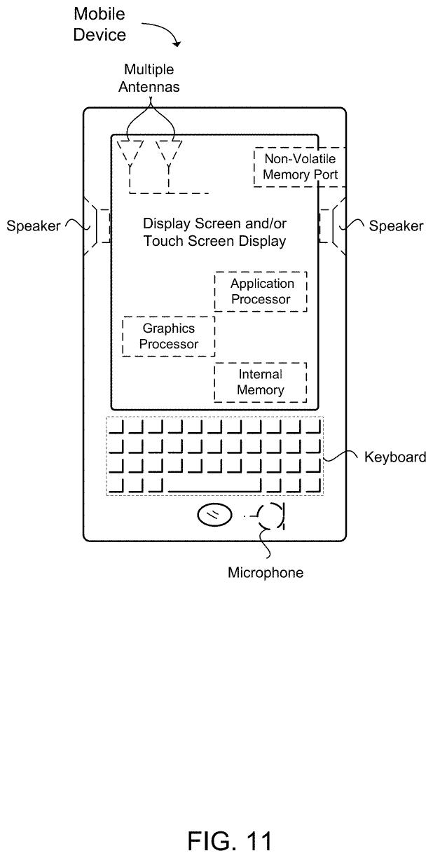

FIG. 11 provides an example illustration of the wireless device, such as a user equipment (UE), a mobile station (MS), a mobile wireless device, a mobile communication device, a tablet, a handset, or other type of wireless device. The wireless device can include one or more antennas configured to communicate with a node, macro node, low power node (LPN), or, transmission station, such as a base station (BS), an evolved Node B (eNB), a baseband processing unit (BBU), a remote radio head (RRH), a remote radio equipment (RRE), a relay station (RS), a radio equipment (RE), or other type of wireless wide area network (WWAN) access point. The wireless device can be configured to communicate using at least one wireless communication standard such as, but not limited to, 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN. The wireless device can also comprise a wireless modem. The wireless modem can comprise, for example, a wireless radio transceiver and baseband circuitry (e.g., a baseband processor). The wireless modem can, in one example, modulate signals that the wireless device transmits via the one or more antennas and demodulate signals that the wireless device receives via the one or more antennas.

FIG. 11 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be integrated with the wireless device or wirelessly connected to the wireless device to provide additional user input. A virtual keyboard can also be provided using the touch screen.

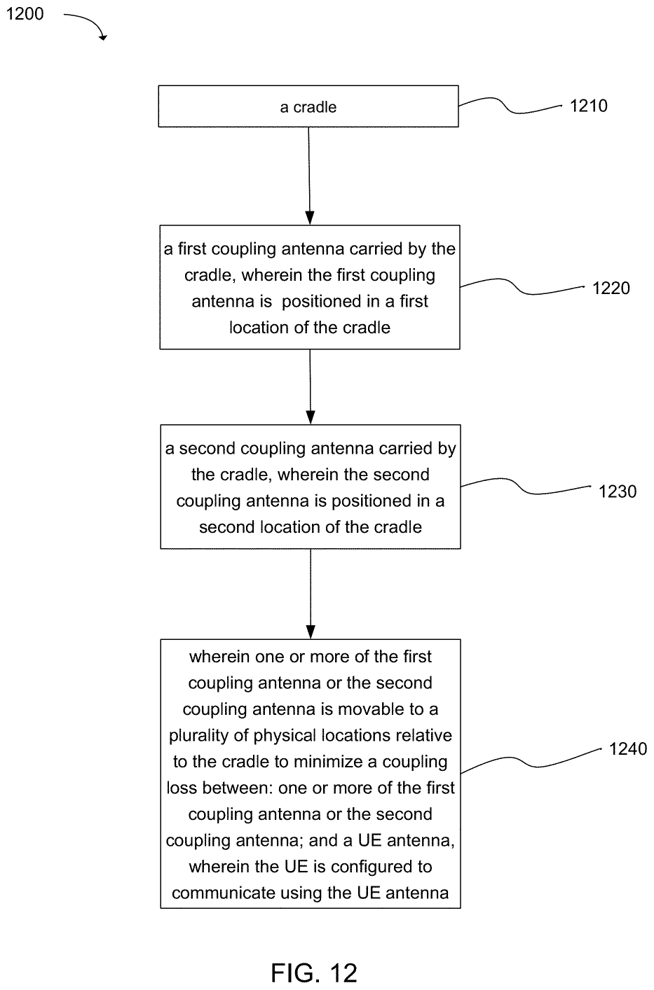

Another example provides a user equipment (UE) dock configured to retain a UE 1200, as shown in the flow chart in FIG. 12. The UE dock can comprise: a cradle, as shown in block 1210. The repeater can comprise: a first coupling antenna carried by the cradle, wherein the first coupling antenna is positioned in a first location of the cradle, as shown in block 1220. The repeater can comprise a second coupling antenna carried by the cradle, wherein the second coupling antenna is positioned in a second location of the cradle wherein, as shown in block 1230. The repeater can comprise one or more of the first coupling antenna or the second coupling antenna is movable to a plurality of physical locations relative to the cradle to minimize a coupling loss between: one or more of the first coupling antenna or the second coupling antenna; and a UE antenna, wherein the UE is configured to communicate using the UE antenna, as shown in block 1240.

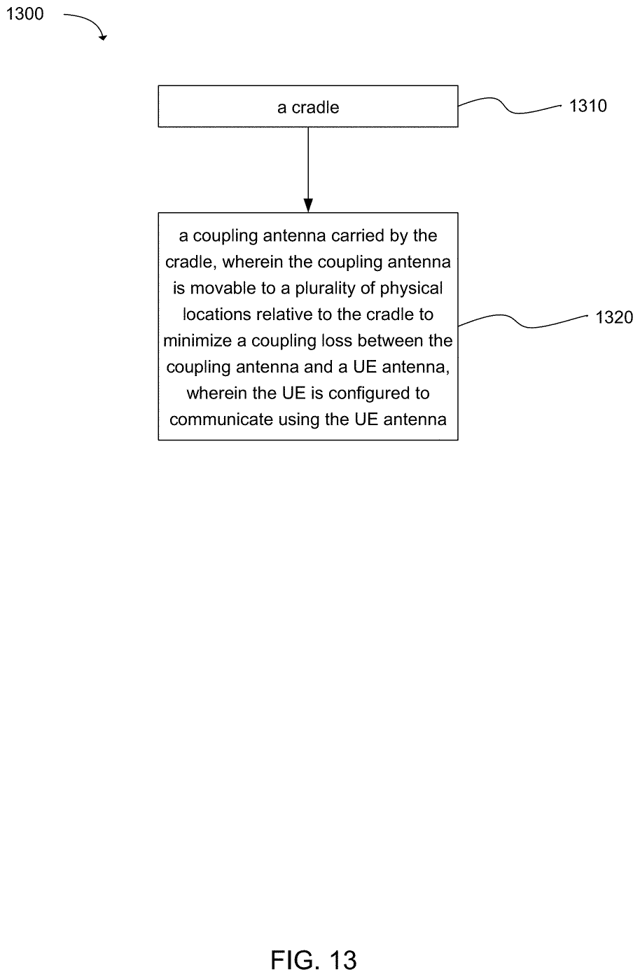

Another example provides a user equipment (UE) dock configured to retain a UE 1300, as shown in the flow chart in FIG. 13. The repeater can comprise: a cradle, as shown in block 1310. The repeater can comprise: a coupling antenna carried by the cradle, wherein the coupling antenna is movable to a plurality of physical locations relative to the cradle to minimize a coupling loss between the coupling antenna and a UE antenna, wherein the UE is configured to communicate using the UE antenna, as shown in block 1320.

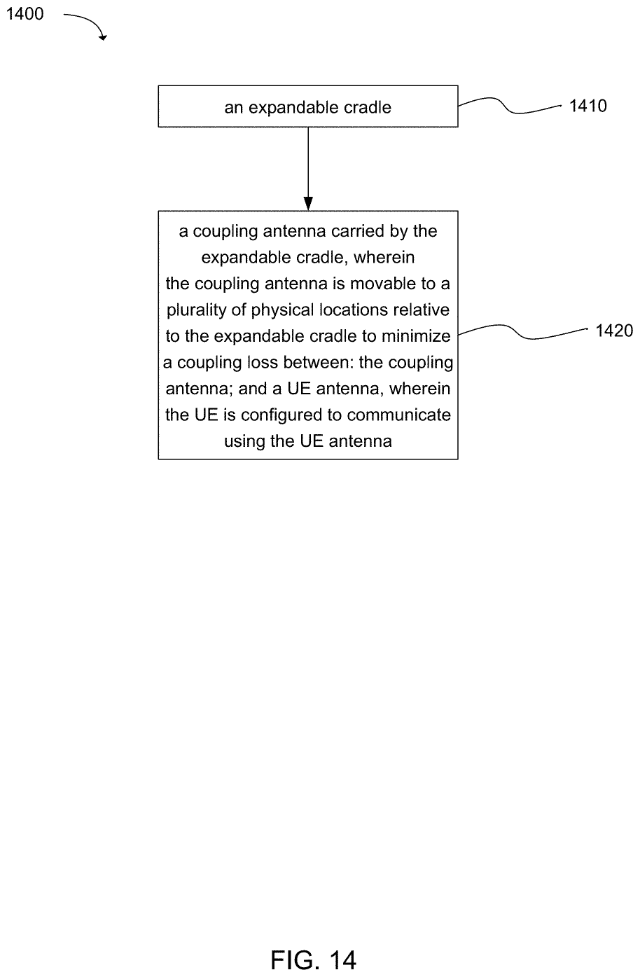

Another example provides a user equipment (UE) dock configured to retain a UE 1400, as shown in the flow chart in FIG. 14. The repeater can comprise an expandable cradle, as shown in block 1410. The repeater can comprise a coupling antenna carried by the expandable cradle, wherein the coupling antenna is movable to a plurality of physical locations relative to the expandable cradle to minimize a coupling loss between: the coupling antenna; and a UE antenna, wherein the UE is configured to communicate using the UE antenna, as shown in block 1420.

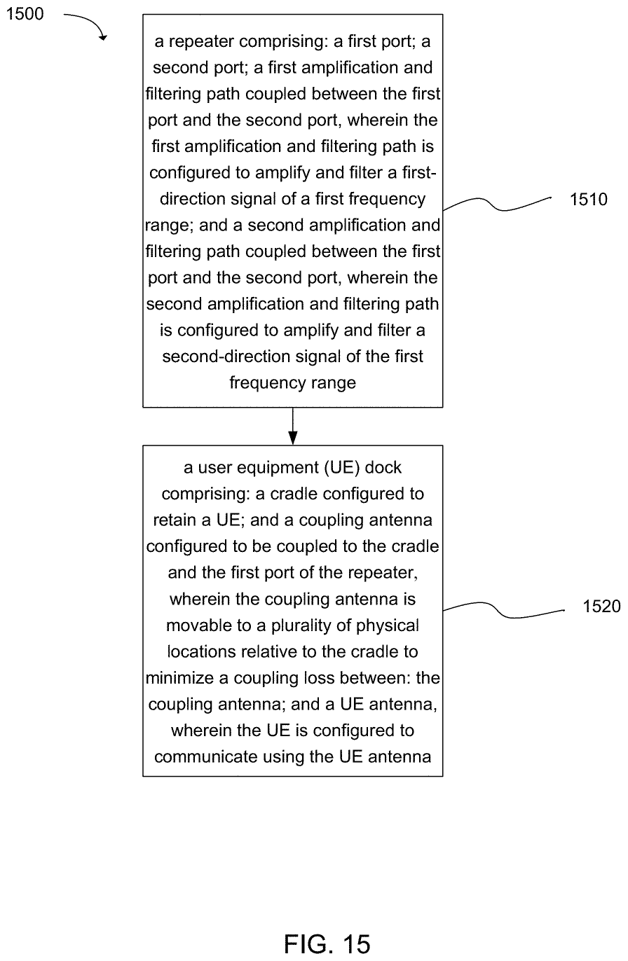

Another example provides a repeater system 1500, as shown in the flow chart in FIG. 15. The repeater system can comprise a repeater comprising: a first port; a second port; a first amplification and filtering path coupled between the first port and the second port, wherein the first amplification and filtering path is configured to amplify and filter a first-direction signal of a first frequency range; and a second amplification and filtering path coupled between the first port and the second port, wherein the second amplification and filtering path is configured to amplify and filter a second-direction signal of the first frequency range, as shown in block 1510. The repeater system can comprise a user equipment (U E) dock comprising: a cradle configured to retain a UE; and a coupling antenna configured to be coupled to the cradle and the first port of the repeater, wherein the coupling antenna is movable to a plurality of physical locations relative to the cradle to minimize a coupling loss between: the coupling antenna; and a UE antenna, wherein the UE is configured to communicate using the UE antenna, as shown in block 1520.

Various techniques, or certain aspects or portions thereof, can take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a random-access memory (RAM), erasable programmable read only memory (EPROM), flash drive, optical drive, magnetic hard drive, solid state drive, or other medium for storing electronic data. The low energy fixed location node, wireless device, and location server can also include a transceiver module (i.e., transceiver), a counter module (i.e., counter), a processing module (i.e., processor), and/or a clock module (i.e., clock) or timer module (i.e., timer). One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations.

As used herein, the term processor can include general purpose processors, specialized processors such as VLSI, FPGAs, or other types of specialized processors, as well as base band processors used in transceivers to send, receive, and process wireless communications.

It should be understood that many of the functional units described in this specification have been labeled as modules, in order to more particularly emphasize their implementation independence. For example, a module can be implemented as a hardware circuit comprising custom very-large-scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices or the like.

In one example, multiple hardware circuits or multiple processors can be used to implement the functional units described in this specification. For example, a first hardware circuit or a first processor can be used to perform processing operations and a second hardware circuit or a second processor (e.g., a transceiver or a baseband processor) can be used to communicate with other entities. The first hardware circuit and the second hardware circuit can be incorporated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network. The modules can be passive or active, including agents operable to perform desired functions.

Reference throughout this specification to “an example” or “exemplary” means that a particular feature, structure, or characteristic described in connection with the example is included in at least one embodiment of the present invention. Thus, appearances of the phrases “in an example” or the word “exemplary” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A user equipment (UE) dock configured to retain a UE, comprising:
a cradle;
a first coupling antenna carried by the cradle, wherein the first coupling antenna is positioned in a first location of the cradle; and
a second coupling antenna carried by the cradle, wherein the second coupling antenna is positioned in a second location of the cradle;
wherein one or more of the first coupling antenna or the second coupling antenna is movable to a plurality of physical locations relative to the cradle to minimize a coupling loss between:
one or more of the first coupling antenna or the second coupling antenna; and
a UE antenna, wherein the UE is configured to communicate using the UE antenna.

2. The UE dock of claim 1, wherein the UE dock further comprises one or more attaching members extending from the cradle for receiving the UE and retaining the UE in the cradle.

3. The UE dock of claim 1, wherein one or more of the first coupling antenna or the second coupling antenna is movable in a horizontal direction relative to the cradle.

4. The UE dock of claim 1, wherein one or more of the first coupling antenna or the second coupling antenna is movable in a vertical direction relative to the cradle.

5. The UE dock of claim 1, wherein one or more of the first coupling antenna or the second coupling antenna has a width substantially similar to a width of the cradle.

6. The UE dock of claim 1, wherein one or more of the first coupling antenna or the second coupling antenna has a width less than a width of the cradle.

7. The UE dock of claim 1, wherein one or more of the first coupling antenna or the second coupling antenna is manually movable relative to the cradle.

8. The UE dock of claim 1, wherein one or more of the first coupling antenna or the second coupling antenna is automatically movable relative to the cradle.

9. The UE dock of claim 8, further comprising:
a motor attached to the dock and one or more of the first coupling antenna or the second coupling antenna, wherein the motor is configured to electronically move the one or more of the first coupling antenna or the second coupling antenna relative to the cradle.

10. The UE dock of claim 1, wherein the first coupling antenna and the second coupling antenna are connected using one or more of a splitter or a diplexer.

11. The UE dock of claim 1, further comprising:
a controller configured to determine an optimal coupling location based on feedback from one or more of the UE or a repeater communicatively coupled to the UE dock.

12. The UE dock of claim 1, wherein the first coupling antenna is positioned in an upper portion of the cradle and the second coupling antenna is positioned in a lower portion of the cradle.

13. A user equipment (UE) dock configured to retain a UE, comprising:
a cradle; and
a coupling antenna carried by the cradle, wherein the coupling antenna is movable to a plurality of physical locations relative to the cradle to minimize a coupling loss between the coupling antenna and a UE antenna, wherein the UE is configured to communicate using the UE antenna.

14. The UE dock of claim 13, wherein the UE dock further comprises one or more attaching members extending from the cradle for receiving the UE and retaining the UE in the cradle.

15. The UE dock of claim 13, wherein the coupling antenna is movable in a horizontal direction relative to the cradle.

16. The UE dock of claim 13, wherein the coupling antenna is movable in a vertical direction relative to the cradle.

17. The UE dock of claim 13, wherein the coupling antenna has a width substantially similar to a width of the cradle.

18. The UE dock of claim 13, wherein the coupling antenna has a width less than a width of the cradle.

19. The UE dock of claim 13, wherein the coupling antenna is manually movable relative to the cradle.

20. The UE dock of claim 13, wherein the coupling antenna is automatically movable relative to the cradle.

21-44. (canceled)
